(19) United States
(12) Patent Application Publication
(10) Pub. No.: US 2015/0193835 A1
(43) Pub. Date: Jul. 9, 2015

(54) COLLAPSIBLE ADS

(71) Applicants: Nainesh Nayudu, Santa Clara, CA (US); Dave Elliott, Los Gatos, CA (US)

(72) Inventors: Nainesh Nayudu, Santa Clara, CA (US); Dave Elliott, Los Gatos, CA (US)

(73) Assignee: EBAY INC., SAN JOSE, CA (US)

(21) Appl. No.: 14/182,152

(22) Filed: Feb. 17, 2014

Related U.S. Application Data
(60) Provisional application No. 61/923,539, filed on Jan. 3, 2014.

(51) Int. Cl. G06Q 30/02

(52) U.S. Cl. CPC G06Q 30/0277

(57) ABSTRACT

In an example embodiment, an area of a web page devoted to displaying an ad is rendered. Then, an ad server is called for ad content. Then, a collapsible ad script is received from the ad server in lieu of ad content. The collapsible ad script is executed, causing a message to be sent to a scripting engine in a web browser, the message causing the web browser to set a height of the area of the web page to zero.

### CROSS-RELATION TO RELATED APPLICATIONS

This application claims priority to U.S. Provisional Application No. 61/923,539 filed Jan. 3, 2014, which is hereby incorporated herein by reference in its entirety.

### TECHNICAL FIELD

This application relates generally to the presentation of advertisements on web sites or Internet-connected applications. More specifically, this application relates to collapsible ads.

### BACKGROUND

Scripted elements in web pages and in applications that are connected to the Internet (e.g., mobile device apps) may be utilized to display ads. Typically these scripted elements contain calls to external ad servers. When the scripted elements are encountered by an interpreter, the calls are made to the external ad servers to retrieve the ads. The scripted element defines an area of the web page or display in which an ad is to be displayed. A retrieved ad is then displayed by the scripted element in the defined area. If no ad is available, the defined area may simply be blank. This may be wasteful, however, in instances where other web page elements could have utilized the space. For example, in an ecommerce web page, the blank area could have been utilized to present more product listings, or links to other areas of the site that contain more product listings.

### BRIEF DESCRIPTION OF DRAWINGS

FIG. 1 is a network diagram depicting a client-server system, within which one example embodiment may be deployed.

FIG. 2 is a block diagram illustrating marketplace and payment applications that, in one example embodiment, are provided as part of application server(s) in the networked system.

FIG. 3 is an example screen capture illustrating such a user interface in accordance with an example embodiment.

FIG. 4 is an example screen capture illustrating a user interface where the ad area 308 is displayed without an ad.

FIG. 5 is an example screen capture illustrating a user interface in accordance with an example embodiment.

FIG. 6 is a ladder diagram illustrating a method of providing a self-collapsing scripted element in accordance with an example embodiment.

FIG. 7 is another ladder diagram illustrating a method of rendering an ad in accordance with an example embodiment.

FIG. 8 is a flow diagram illustrating a method in accordance with an example embodiment.

FIG. 9 is a block diagram illustrating a mobile device, according to an example embodiment.

FIG. 10 is a block diagram of machine in the example form of a computer system within which instructions may be executed for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, a self-collapsing scripted element is provided. This allows an advertisement to be included if available and excluded if unavailable, without requiring additional code in the page including the ad. For example, if a third-party ad server is able to deliver an ad for the space, then the advertisement can be included. If not, then, assuming the developer chose to make the “ad” (more precisely the ad space) self-collapsing, then no ad will be displayed at that point. A developer may choose to either include a traditional ad or a self-collapsing ad, based on the placement of the ad and the layout of the page. Choosing whether to use a self-collapsing ad may also be based on an analysis of user interaction with other elements that replace the missing ad.

As an example, an ecommerce web site may have ad placements across multiple pages in different sizes. In situations where there is a lower sell-through rate for these ad placements, it may be desirable to collapse them when there are no paid ads to display. This frees up real estate on the page giving premium position to other competing content and/or enhancing user focus on the site content. In another example embodiment, this decision may be made on a per-user basis. For example, a particular user's past behavior as far as clicking on advertisements may be utilized to help determine whether to make ads collapsible. This information may even be granulated at a fine level, such as determining that the user often clicks on ads at the top of a page but rarely clicks on ads on the side of a page. In another example embodiment, other information than just user click-through may be utilized in making this determination. For example, demographic or profile information may be used to help determine whether to make an advertisement self-collapsing.

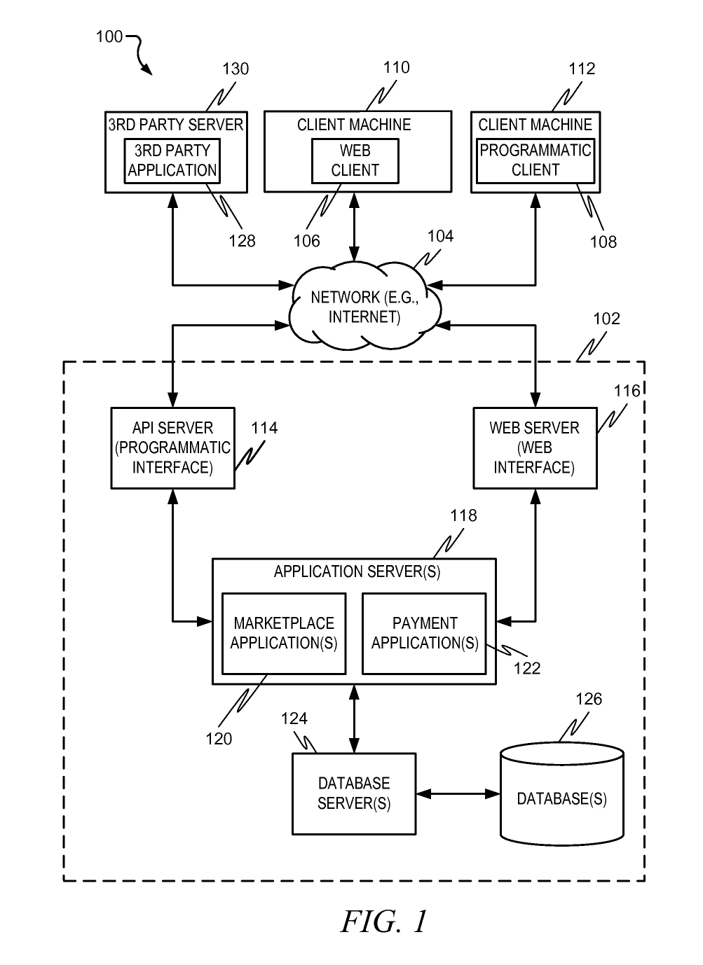

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)), to one or more clients. FIG. 1 illustrates, for example, a web client 106 (e.g., a browser, such as the Internet Explorer® browser developed by Microsoft® Corporation of Redmond, Wash. State) and a programmatic client 108 executing on respective devices 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the Turbo Lister application developed by eBay Inc., of San Jose, Calif.) to enable sellers to author and manage listings on the networked system 102 in an offline manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

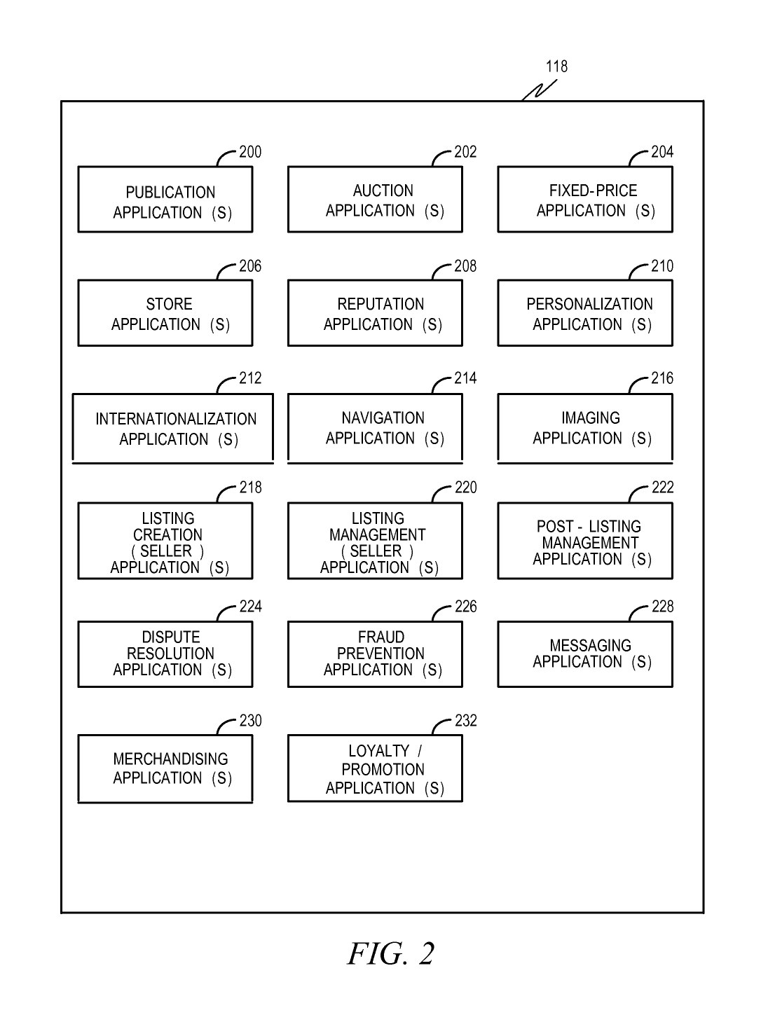

FIG. 2 is a block diagram illustrating marketplace and payment applications 120 and 122 that, in one example embodiment, are provided as part of application server(s) 118 in the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information by the networked system 102) according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks 104.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

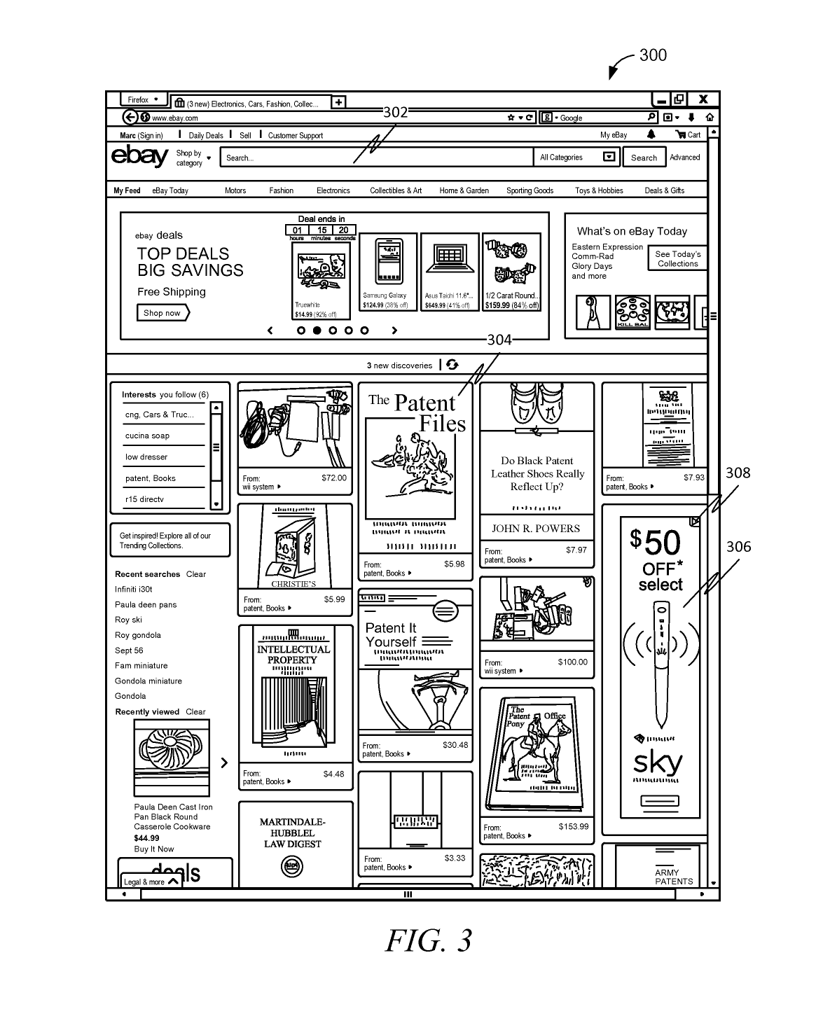

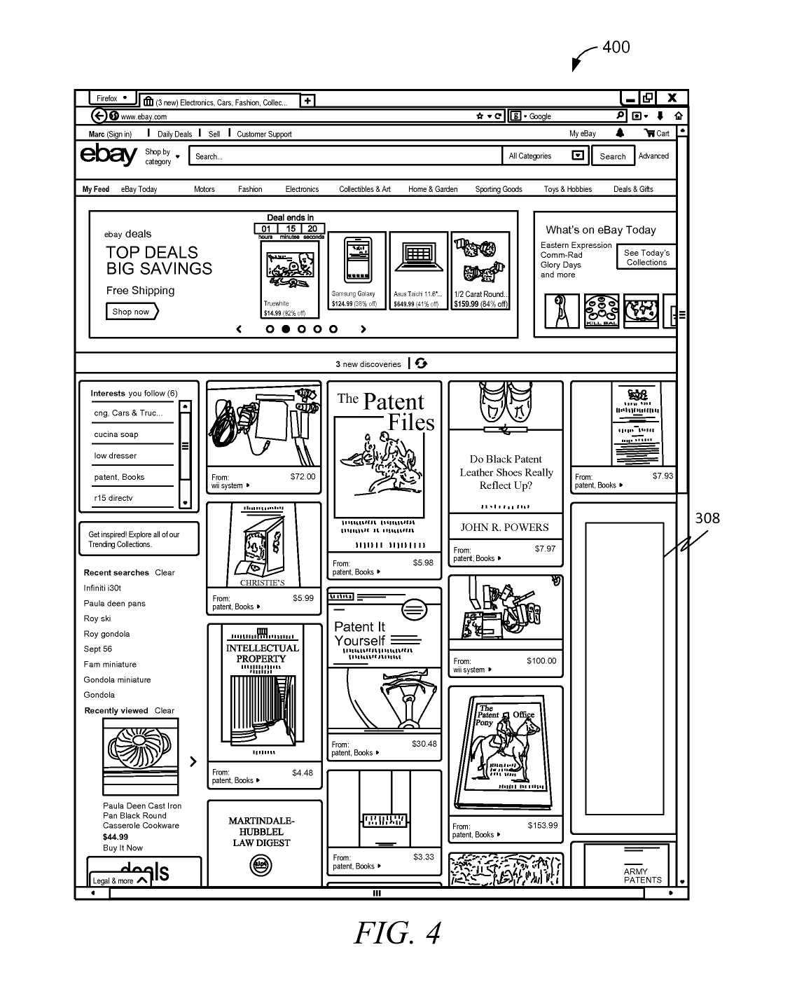

As described briefly above, a user interface presented to a user may provide a platform for the user to browse and/or search for ecommerce listings on the ecommerce site. FIG. 3 is an example screen capture illustrating such a user interface in accordance with an example embodiment. The user interface 300 may be a web page including a search area 302 and a product listing area 304. Also presented may be one or more ads 306 in ad area 308. In some example embodiments, these ads 306 are provided by a third party ad server. As such, the ecommerce site displaying the ads is not always in control of whether or not an ad, such as ad 306, will actually be provided at runtime by the third party ad server, leaving the possibility that the ad area 308 may be displayed but displayed blank. This is depicted in FIG. 4. FIG. 4 is an example screen capture illustrating a user interface 400 where the ad area 308 is displayed without an ad. This wastes valuable real estate on the user interface 400.

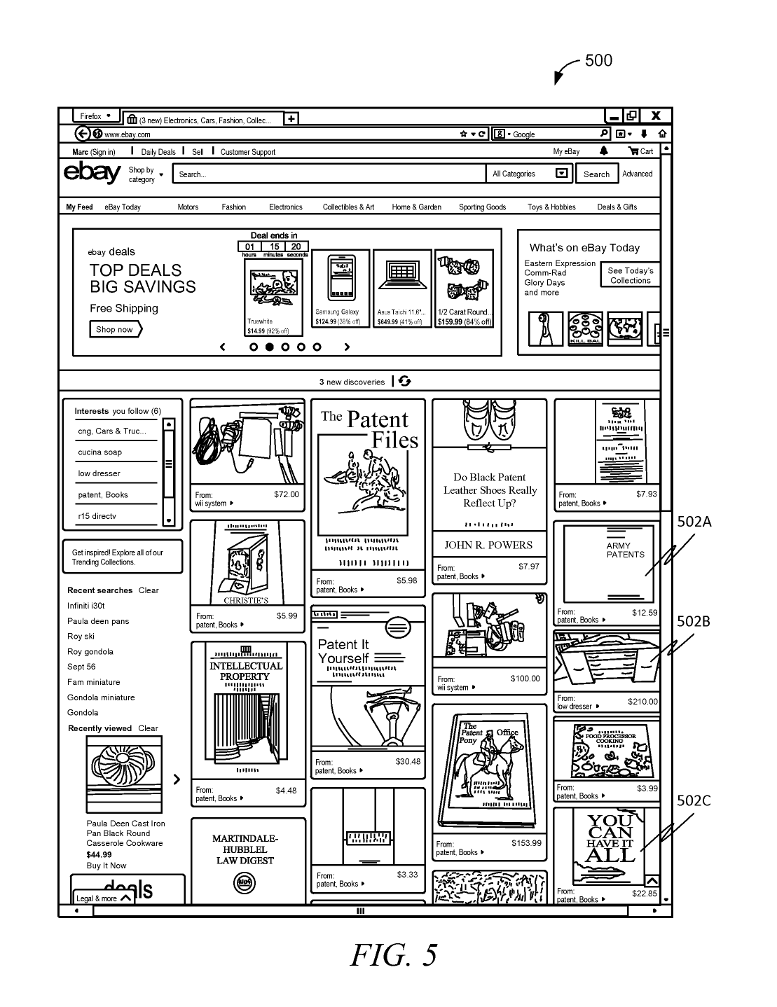

In an example embodiment a self-collapsing scripted element is provided. This allows an advertisement to be included if available and excluded if unavailable, without requiring additional code in the page including the ad. FIG. 5 is an example screen capture illustrating a user interface 500 in accordance with an example embodiment. Here, the advertisement has been excluded because it is unavailable, and the self-collapsing scripted element on the web page has collapsed, resulting in no ad area such as ad area 308 of FIG. 4. The result is that other elements on the user interface 500, including additional items 502A-502C, are now visible when they weren't before (without scrolling).

An iframe is a scripted element used to embed a document or content item within another element of a web page (or the web page itself). In an example embodiment, an iframe is provided with script that allows it to be self-collapsing. One issue is that normally an advertisement or other third party content is not able to modify a web page or web page element, due to security embedded in browsers. As such, a novel method of passing messages between the ad placement element and the browser is provided.

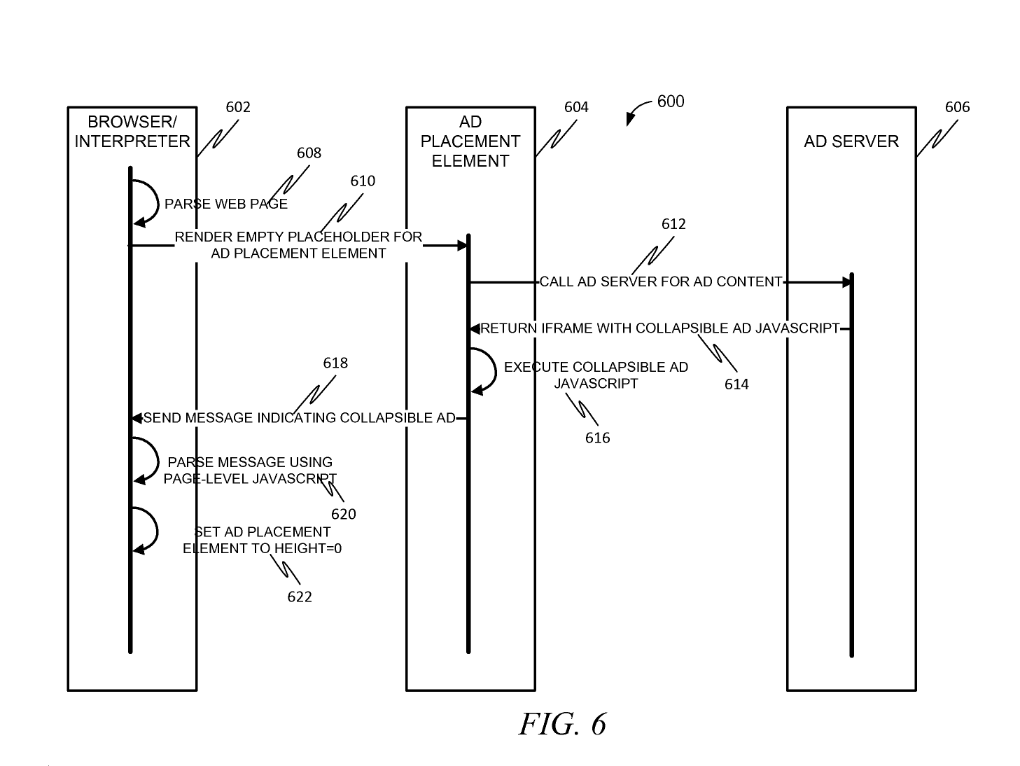

FIG. 6 is a ladder diagram illustrating a method 600 of providing a self-collapsing scripted element in accordance with an example embodiment. This method 600 involves three entities: the browser/interpreter 602, the ad placement element 604, and the ad server 606. At operation 608, the browser/interpreter 602 parses a web page. At operation 610, the browser/interpreter 602 renders an empty placeholder for an ad placement element. At operation 612, the ad placement element 604 then calls the ad server 606 for content. At operation 614, the ad server returns 606 an iframe with collapsible ad script. This may be in the form of, for example, JavaScript. At operation 616, the ad placement element 604 executes the collapsible ad script. This causes, at operation 618, a message to be sent to the browser/interpreter 602 indicating that the ad is collapsible. At operation 620, the browser/interpreter 602 then parses the message using a page-level script. At operation 622, the ad placement element 604 is set to a height of 0, which essentially causes it to collapse.

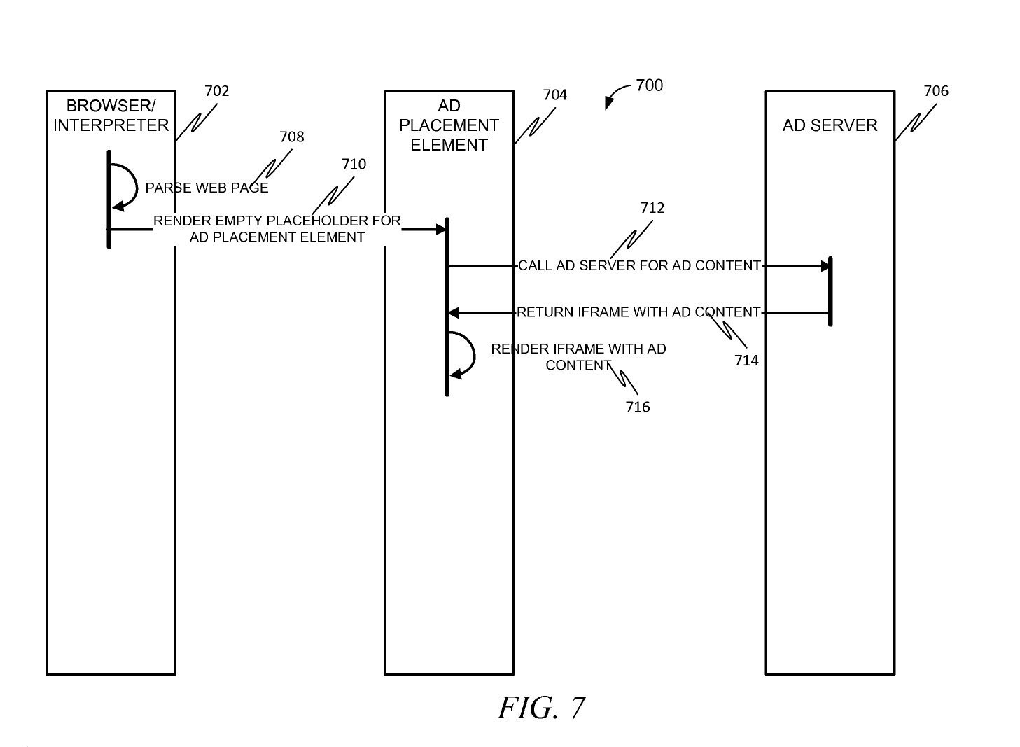

FIG. 7 is another ladder diagram illustrating a method 700 of rendering an ad in accordance with an example embodiment. This method 700 may occur when there is an ad being returned by the ad server, and thus there is no need for a collapsible ad script. This method 700 involves three entities: the browser/interpreter 702, the ad placement element 704, and the ad server 706. At operation 708, the browser/interpreter 702 parses a web page. At operation 710, the browser/interpreter 702 renders an empty placeholder for an ad placement element. At operation 712, the ad placement element 704 then calls the ad server 706 for content. At operation 714, the ad server 706 returns an iframe with ad content. At operation 716, the ad placement element 704 renders the iframe with the ad content.

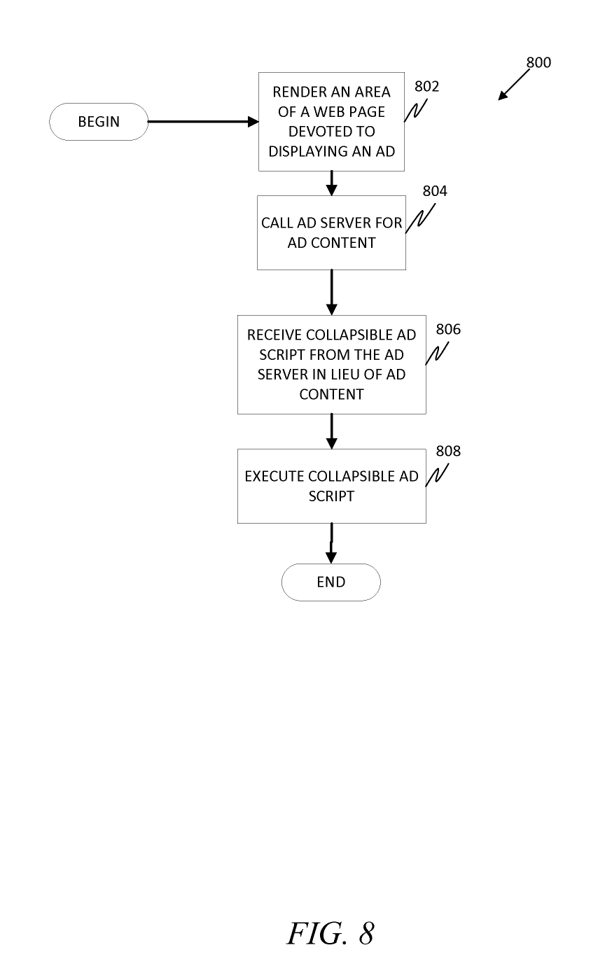

FIG. 8 is a flow diagram illustrating a method 800 in accordance with an example embodiment. At operation 802, an area of a web page devoted to displaying an ad may be rendered. At operation 804, an ad server may be called for ad content. At operation 806, a collapsible ad script may be received from the ad server in lieu of ad content. At operation 808, the collapsible ad script may be executed, causing a message to be sent to a scripting engine in a web browser, the message causing the web browser to set a height of the area of the web page to zero.

It should be noted that in some embodiments the message sent from the ad placement element may include the domain from which the message was sent. This allows the browser/interpreter to check to make sure the domain that sent the message is the one that it was expecting to send the message. This may be useful for security purposes to ensure malicious elements are not able to modify aspects of the page rendered by the browser/interpreter.

While the above description focuses on web pages, similar techniques may be utilized in dedicated applications. For example, an ecommerce service may have a web site used by desktop and laptop customers, but also may provide a dedicated application downloadable by users and executable on smartphones and/or tablets. Other mobile devices, such as automobiles and watches, are also possible. In such cases, the dedicated application can utilize the same techniques as a web browser to implement collapsible ads.

### Example Mobile Device

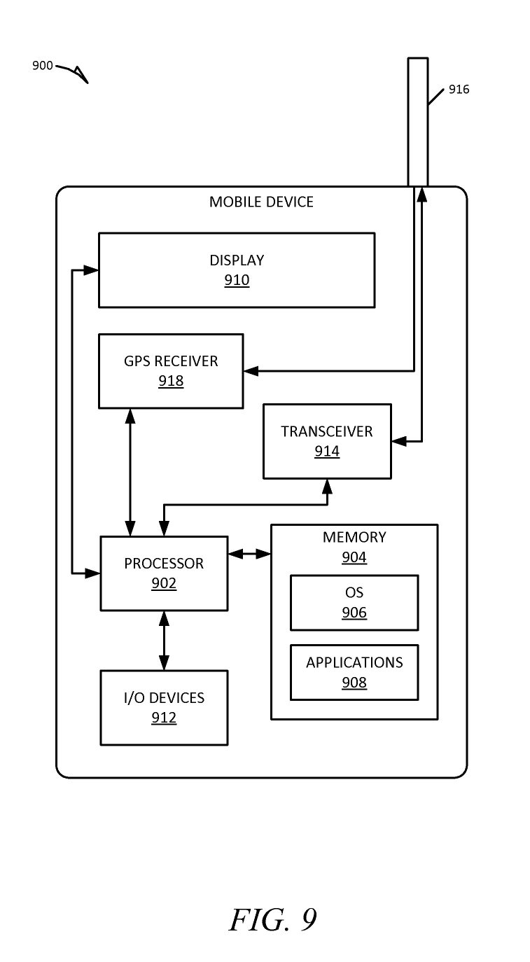

FIG. 9 is a block diagram illustrating a mobile device 900, according to an example embodiment. The mobile device 900 may include a processor 902. The processor 902 may be any of a variety of different types of commercially available processors suitable for mobile devices (for example, an XScale architecture microprocessor, a microprocessor without interlocked pipeline stages (MIPS) architecture processor, or another type of processor 902). A memory 904, such as a random access memory (RAM), a flash memory, or other type of memory, is typically accessible to the processor 902. The memory 904 may be adapted to store an operating system (OS) 906, as well as application programs 908, such as a mobile location enabled application that may provide LBSs to a user. The processor 902 may be coupled, either directly or via appropriate intermediary hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 902 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field-programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure processor 902, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902, not only residing within a single machine, but deployed across a number of machines. In some example embodiments, the processor 902 or processors 902 may be located in a single location (e.g., within a home environment, an office environment or as a server farm), while in other embodiments the processors 902 may be distributed across a number of locations.

The one or more processors 902 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 902, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 902 executing a computer program to perform functions by operating on input data and generating output. Method operations can also be performed by, and apparatus of example embodiments may be implemented as, special purpose logic circuitry, e.g., a field-programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 902), or a combination of permanently and temporarily configured hardware may be a design choice. Below are set out hardware (e.g., machine) and software architectures that may be deployed, in various example embodiments.

### Example Machine Architecture and Machine-Readable Medium

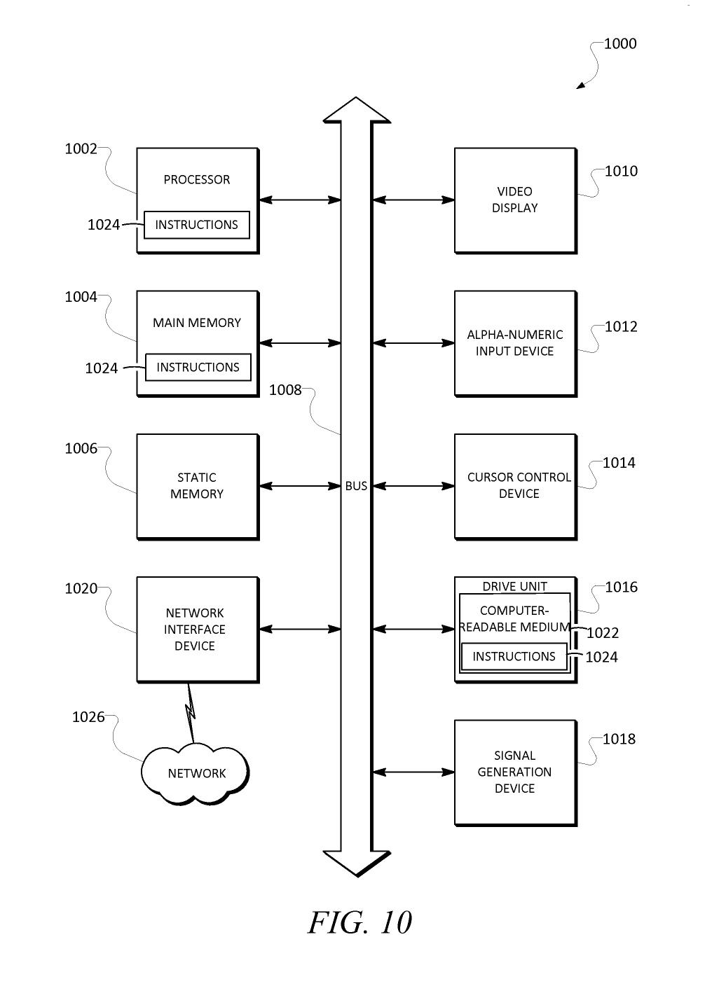

FIG. 10 is a block diagram of machine in the example form of a computer system 1000 within which instructions 1024 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1010 (e.g., a keyboard or a touch-sensitive display screen), a user interface (UI) navigation (e.g., cursor control) device 1014 (e.g., a mouse), a data storage unit 1016, a signal generation device 1018 (e.g., a speaker) and a network interface device 1020.

### Machine-Readable Medium

The data storage unit 1016 includes a computer-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting computer-readable media 1022.

While the computer-readable medium 1022 is shown in an example embodiment to be a single medium, the term “computer-readable medium” may include a single medium or multiple media (e.g., a centralized or distributed database, and/or associated caches and servers) that store the one or more instructions 1024 or data structures. The term “computer-readable medium” shall also be taken to include any tangible medium that is capable of storing, encoding or carrying instructions 1024 for execution by the machine and that cause the machine to perform any one or more of the methodologies of the present disclosure or that is capable of storing, encoding or carrying data structures utilized by or associated with such instructions 1024. The term “computer-readable medium” shall accordingly be taken to include, but not be limited to, solid-state memories, and optical and magnetic media. Specific examples of computer-readable media 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMAX networks). The term “transmission medium” shall be taken to include any intangible medium that is capable of storing, encoding or carrying instructions 1024 for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system comprising:
a web browser executable by a processor and configured to parse a web page, the web page including an ad placement element that, when executed:
renders an area of a web page devoted to displaying an ad;
calls an ad server for ad content;
receives a collapsible ad script from the ad server in lieu of ad content; and
executes the collapsible ad script, causing a message to be sent to a scripting engine in the web browser;
the web browser further configured to:
in response to the message from the ad placement element, sets a height of the area of the web page to zero.

2. The system of claim 1, wherein the collapsible ad script is received with an iframe.

3. The system of claim 1, wherein the web browser is further configured to parse the message using a page-level scripting language.

4. The system of claim 1, wherein the ad placement element is further configured to:
call an ad server for additional ad content;
receive ad content in response to the call for additional ad content; and
render the ad content.

5. The system of claim 1, wherein the web page is an ecommerce web page displaying listings of items for sale.

6. The system of claim 5, wherein the setting of the height of the area of the web page to zero causes additional listings of items for sale to be displayed where the area of the web page devoted to displaying an ad had been rendered.

7. The system of claim 1, wherein the collapsible ad script is executed on the same page as a non-collapsible ad script.

8. A method comprising:
rendering an area of a web page devoted to displaying an ad;
calling an ad server for ad content;
receiving a collapsible ad script from the ad server in lieu of ad content; and
executing the collapsible ad script, causing a message to be sent to a scripting engine in a web browser, the message causing the web browser to set a height of the area of the web page to zero.

9. The method of claim 8, wherein the collapsible ad script is received with an iframe.

10. The method of claim 8, wherein the web browser is configured to parse the message using a page-level scripting language.

11. The method of claim 8, further comprising:
calling an ad server for additional ad content;
receiving ad content in response to the call for additional ad content; and
rendering the ad content.

12. The method of claim 8, wherein the web page is an ecommerce web page displaying listings of items for sale.

13. The method of claim 12, wherein the setting of the height of the area of the web page to zero causes additional listings of items for sale to be displayed where the area of the web page devoted to displaying an ad had been rendered.

14. The method of claim 8, wherein the collapsible ad script is executed on the same page as a non-collapsible ad script.

15. A non-transitory machine-readable storage medium comprising instructions, which when implemented by one or more machines, cause the one or more machines to perform operations comprising:
rendering an area of a web page devoted to displaying an ad;
calling an ad server for ad content;
receiving a collapsible ad script from the ad server in lieu of ad content; and
executing the collapsible ad script, causing a message to be sent to a scripting engine in a web browser, the message causing the web browser to set a height of the area of the web page to zero.

16. The non-transitory machine-readable storage medium of claim 15, wherein the collapsible ad script is received with an iframe.

17. The non-transitory machine-readable storage medium of claim 15, wherein the web browser is configured to parse the message using a page-level scripting language.

18. The non-transitory machine-readable storage medium of claim 15, further comprising:
calling an ad server for additional ad content;
receiving ad content in response to the call for additional ad content; and
rendering the ad content.

19. The non-transitory machine-readable storage medium of claim 15, wherein the web page is an ecommerce web page displaying listings of items for sale.

20. The non-transitory machine-readable storage medium of claim 19, wherein the setting of the height of the area of the web page to zero causes additional listings of items for sale to be displayed where the area of the web page devoted to displaying an ad had been rendered.
